(19) United States
(12) Patent Application Publication
(10) Pub. No.: US 2008/0208993 A1
(43) Pub. Date: Aug. 28, 2008

(54) Method For Distributing New Services in an Internet Multimedia Subsystem (Ims), and a Node Adapted Therefore

(76) Inventor: Robert Skog, Hasselby (SE)

Correspondence Address: ERICSSON INC., 6300 LEGACY DRIVE, M/S EVR 1-C-11, PLANO, TX, 75024, US

(21) Appl. No.: 11/916,595

(22) PCT Filed: Jun. 10, 2005
(86) PCT No.: PCT/SE2005/000877

§ 371 Date: Dec. 5, 2007

(51) Int. Cl. G06F 15/16

(52) U.S. Cl. 709/206

(57) ABSTRACT

The present invention relates to a node in an Internet Multimedia Subsystem, IMS, adapted to carry Session Initiated Protocol, SIP, traffic between inviting and invited users, comprising means for distributing at least one address from where an SIP based application, required for a communication between the users, wherein the type of communication is defined in the invitation form the inviting user, can be downloaded. The node comprises means for including the at least one address from where the SIP based application can be downloaded into a SIP message from the inviting user to the invited user, wherein the SIP message is associated with the invitation for immediate communication via the required application. The present invention also relates to a method in an IMS for distributing the at least one address from where an SIP based application can be downloaded.

### FIELD OF THE INVENTION

The present invention relates to arrangements in an Internet Multimedia Subsystem (IMS), In particular, it relates to an arrangement for distributing new services.

### BACKGROUND

The Session Initiated Protocol (SIP) based technology implemented in IMS is a technology environment for person-to-person media exchange including voice telephony.

The IP Multi-Media Subsystem (IMS) is an IP multimedia and telephony core network. It is defined by 3GPP and 3GPP2 standards and organizations based on IETF Internet protocols. IMS is access independent as it supports IP to IP sessions over wireline IP and packet data along with GSM/EDGE/UMTS and other wireless packet data applications. FIG. 1 schematically shows IMS connected to a UMTS. It should be noted that only the packet switched part of the UMTS is shown. IMS is connected to the UMTS network via the Gateway GPRS Support Node (GGSN). The IMS may also be connected to further networks as the PS transit network as illustrated in FIG. 1. IMS comprises session control, connection control and an applications services framework along with subscriber and services data. It enables the operators to offer multimedia services based on and built upon Internet applications, services and protocols. These protocols include SIP, which is used to manage the IP multimedia sessions.

The Session Initiation Protocol (SIP) is an application layer control signalling protocol created with the aim of creating, modifying, and terminating voice, video, and multimedia sessions independently from the underlying transport protocol used and from the kind of session instantiated. The preferred transport protocol for SIP is UDP, to avoid the time spent in TCP connection set-up and teardown. The SIP protocol itself does not provide services, but rather makes available a set of primitives that other protocols or applications can use to actually implement such services. The strength of SIP lies in its flexibility: the protocol is open to extensions for giving support to new applications requiring a new set of capabilities that the protocol itself is not able to support. SIP uses the Session Description Protocol (SDP), carried as an opaque body in SIP messages, to describe multimedia sessions. Thanks to SDP, the parties involved in a SIP session can negotiate their receiving capabilities and communicate which media streams they are able to process; the information is carried in a human-readable text format. A SIP address is typically a Uniform Resource Identifier (URI). Thus the SIP URI is a unique name given to a SIP device and a SIP address can be embedded in Web pages and can therefore e.g. be integrated as part of Click to talk implementations. SIP transparently supports name mapping and redirection services, allowing the implementation of ISDN and Intelligent Network telephony subscriber services. These facilities also enable personal mobility which is based on the use of the SIP URI. Calling parties and called parties are identified by SIP addresses.

The most common SIP operation is the invitation, i.e. the SIP INVITE. Thus, SIP can invite participants to already existing sessions, such as multicast conferences. Media can be added to (and removed from) an existing session. SIP is further described in RFC 3261.

SIP INVITE is the first message sent to establish a session between two parties.

Examples of other SIP messages are SIP OPTION, used to query the other part for its capabilities, SIP RE-INVITE, used to modify existing session that exist between two parties, and SIP MESSAGE used to send a message to the other part.

FIG. 2 shows a typical example of a SIP message exchange between two users, Alice and Bob, wherein Alice invites Bob to play chess. Each message is labeled with the letter “F” and a number for reference by the text. In this example, Alice uses a SIP application on her PC (referred to as a softphone) to call Bob on his SIP phone over the Internet. Also shown are two SIP proxy servers that act on behalf of Alice and Bob to facilitate the session establishment. This typical arrangement is often referred to as the “SIP trapezoid” as shown by the geometric shape of the dotted lines in FIG. 2. It should however be noted that the scenario disclosed in FIG. 2, shows SIP defined by Internet Engineering Task Force (IETF). In SIP adapted for IMS, wherein the present invention may be implemented, comprises additional nodes, but the main principles are the same.

Alice “calls” Bob using his SIP identity, a type of Uniform Resource Identifier (URI) called a SIP URI. It has a similar form to an email address, typically containing a username and a host name. In this case, it is sip:bob@biloxi.com, where biloxi.com is the domain of Bob's SIP service provider. Alice has a SIP URI of sip:alice@gatlanta.com. Alice might have typed in Bob's URI or perhaps clicked on a hyperlink or an entry in an address book.

SIP is based on an HTTP-like request/response transaction model. Each transaction consists of a request that invokes a particular method, or function, on the server and at least one response. In this example, the transaction begins with Alice's softphone sending an INVITE request addressed to Bob's SIP URI. INVITE is an example of a SIP method that specifies the action that the requestor (Alice) wants the server (Bob) to take. The INVITE request contains a number of header fields. Header fields are named attributes that provide additional information about a message. The ones present in an INVITE include a unique identifier for the call, the destination address, Alice's address, and information about the type of session that Alice wishes to establish with Bob. The INVITE procedure is illustrated in FIG. 2.

The structure of a SIP message is shown below. However, Alice's SDP is not shown. The first line of the text-encoded message contains the method name (INVITE). The lines that follow are a list of header fields. This example contains a minimum required set. The header fields are briefly described below:
INVITE sip:bob@biloxi.com SIP/2.0
Via: SIP/2.0/UDP pc33.atlanta.com;branch=z9hG4bK776asdhds
Max-Forwards: 70
To: Bob <sip:bob@biloxi.com>
From: Alice <sip:alice@atlanta.com>;tag=1928301774
Call-ID: a84b4c76e66710@pc33.atlanta.com
CSeq: 314159 INVITE
Contact: <sip:alice@pc33.atlanta.com>
Content-Type: application/sdp
Content-Length: 142

“Via” contains the address (pc33.atlanta.com) at which Alice is expecting to receive responses to this request. It also contains a branch parameter that identifies this transaction.

“To” contains a display name (Bob) and a SIP or SIPS URI (sip:bob@biloxi.com) towards which the request was originally directed. Display names are described in RFC 2822[3].

“From” also contains a display name (Alice) and a SIP or SIPS URI (sip:alice@atlanta.com) that indicate the originator of the request. This header field also has a tag parameter containing a random string (1928301774) that was added to the URI by the softphone. It is used for identification purposes.

“Call-ID” contains a globally unique identifier for this call, generated by the combination of a random string and the softphone's host name or IP address. The combination of the To tag, From tag, and Call-ID completely defines a peer-to-peer SIP relationship between Alice and Bob and is referred to as a dialog.

“Cseq” or Command Sequence contains an integer and a method name. The CSeq number is incremented for each new request within a dialog and is an ordinary sequence number.

“Contact” contains a SIP or SIPS URI that represents a direct route to contact Alice, usually composed of a username at a fully qualified domain name (FQDN). While an FQDN is preferred, many end systems do not have registered domain names, so IP addresses are permitted.

While the Via header field tells other elements where to send the response, the Contact header field tells other elements where to send future requests.

“Max-Forwards” serves to limit the number of hops a request can make on the way to its destination. It consists of an integer that is decremented by one at each hop.

“Content-Type” contains a description of the message body (not shown).

“Content-Length” contains an octet (byte) count of the message body.

The complete set of SIP header fields is defined in Section 20 of RFC 3261.

The details of the session, such as the type of media, codec, or sampling rate, are not described using SIP. Rather, the body of a SIP message contains a description of the session, encoded in some other protocol format. One such format is the Session Description Protocol (SDP) further described in RFC 2327.

Bob's SIP phone receives the INVITE and alerts Bob to the incoming call from Alice so that Bob can decide whether to answer the call, that is, Bob's phone rings. The communication is interrupted in this stage if the Bob's phone detects (by inspecting the so called service identifiers) that it has not access to the chess application required, indicated in the invitation. The service identifiers are further described below.

Bob's SIP phone indicates this in a 180 (Ringing) response, which is routed back through the two proxies in the reverse direction. Each proxy uses the Via header field to determine where to send the response and removes its own address from the top. As a result, although DNS and location service lookups were required to route the initial INVITE, the 180 (Ringing) response can be returned to the caller without lookups or without state being maintained in the proxies. This also has the desirable property that each proxy that sees the INVITE will also see all responses to the INVITE.

When Alice's softphone receives the 180 (Ringing) response, it passes this information to Alice, perhaps using an audio ringback tone or by displaying a message on Alice's screen. In this example, Bob decides to answer the call. When he picks up the handset, his SIP phone sends a 200 (OK) response to indicate that the call has been answered. The 200 (OK) contains a message body with the SDP media description of the type of session that Bob is willing to establish with Alice. As a result, there is a two-phase exchange of SDP messages: Alice sent one to Bob, and Bob sent one back to Alice. This two-phase exchange provides basic negotiation capabilities and is based on a simple offer/answer model of SDP exchange. If Bob did not wish to answer the call or was busy with another call, an error response would have been sent instead of the 200 (OK), which would have resulted in no media session being established.

In this case, the 200 (OK) is routed back through the two proxies and is received by Alice's softphone, which then stops the ringback tone and indicates that the call has been answered. Finally, Alice's softphone sends an acknowledgement message, ACK, to Bob's SIP phone to confirm the reception of the final response (200 (OK)). In this example, the ACK is sent directly from Alice's softphone to Bob's SIP phone, bypassing the two proxies. This occurs because the endpoints have learned each other's address from the Contact header fields through the INVITE/200 (OK) exchange, which was not known when the initial INVITE was sent. The lookups performed by the two proxies are no longer needed, so the proxies drop out of the call flow. This completes the INVITE/200/ACK three-way handshake used to establish SIP sessions.

Alice and Bob's media session has now begun, and they send media packets (in this case for example chess draws) using the format to which they agreed in the exchange of SDP. In general, the end-to-end media packets take a different path from the SIP signaling messages.

During the session, either Alice or Bob may decide to change the characteristics of the media session. This is accomplished by sending a re-INVITE containing a new media description.

Thus, if the receiving mobile terminal does not have the application/service installed that the invitation requires, it needs to send an error message back to the initiating mobile terminal. This means that no communication can be set-up between the two terminals.

### SUMMARY OF THE INVENTION

The objective problem of the present invention is therefore to provide arrangements that facilitate an improved distribution for applications providing services within an IMS.

The object of the present invention is achieved by a method according to claim 1 and by a node according to claim 14.

Preferred embodiments are defined by the dependent claims.

In order to provide an improved distribution of new applications, the present invention provides a method and a node for including an address in a SIP message, e.g. in the header of the SIP INVITE message, where the requested application can be downloaded. The transmission of said SIP message is associated with an invitation for immediate communication via the required application.

The main advantage is that the distribution of the address such as a URLs where it is possible to download applications is directly associated with the use of said application. I.e. the user receiving the URL is able to interact with another user by communicating via the application immediately.

A further advantage with the present invention is that it makes distribution and deployment of new applications/services easier and therefore promotes invention of new applications/services since the distribution of the link to the concerned application is associated with an immediate possible use.

A further advantage is that the end-user will benefit that he/she will be able to communicate with other users that already have downloaded the application/service since he/she will actively be informed of new communication applications/services when other end-users invite him/her.

### DRAWINGS

FIG. 1 illustrates schematically an Internet Multimedia Subsystem.

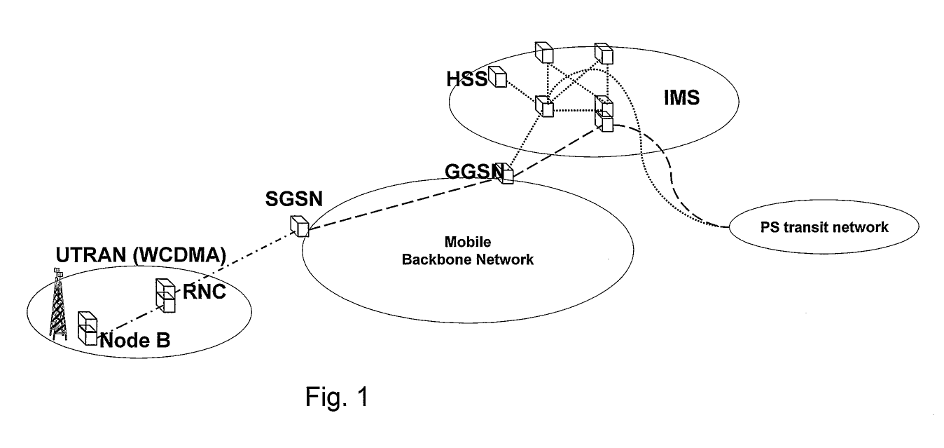

FIG. 2 illustrates a SIP session setup example.

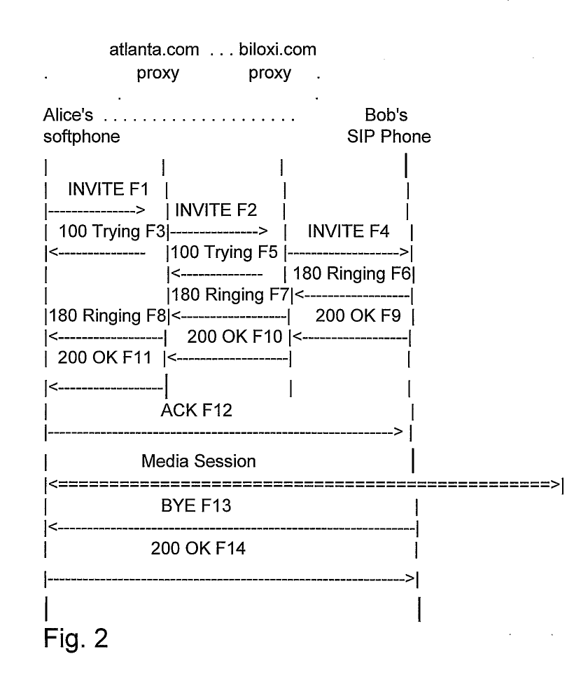

FIG. 3 illustrates a flowchart describing the method of the present invention.

### DETAILED DESCRIPTION OF THE PRESENT INVENTION

The present invention will be described more fully hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

The object of the present invention is to provide a method and arrangements for distributing a service. That is achieved according to the present invention by providing arrangements for distributing an address to a terminal of an end-user not having access to a SIP based application required for the service, where an application providing a specific service can be downloaded. The basic idea of the present invention is that the distribution is associated with an invitation for that specific service. That implies that the invited user has the possibility to use the application immediately and is therefore encouraged to download the application for immediate use. The arrangements according to the present invention comprise thus means for inserting at least one address in a SIP message associated with the invitation, where the application providing the specific service can be downloaded. The insertion of the address in the SIP message is accomplished by inspecting the SIP message, transmitted from the inviting party, wherein the SIP message comprises information indicating the application to be used and where said application can be downloaded.

According to a first embodiment of the present invention, the address from where the application may be downloaded is found by a node comprising means for inspecting the service identifier. The service identifier is a parameter carried in the header of a SIP message. The service identifier is a unique global identifier identifying the service and associated with an address where the application for the service may be downloaded. An example of a service identifier is +g.ericsson.chess identifying a chess application.

The inspecting node knows then, based on the inspection, which address to insert. The address is preferably a URL. It should be noted that the address may also be a unified resource identifier (URI) or a unified resource name (URN), in which the latter case the logical address is translated into a physical address upon client software retrieval.

The node according to a further embodiment is implemented within an IMS. Possible nodes are the sending terminal, sending operator P-CSCF, S-CSCF, Application Server or terminating operator P-CSCF, S-CSCF, Application Server. Thus, at least one of said nodes comprises means for inspecting the service identifier of the SIP message, and based on the inspection, the at least one of said nodes is then able to determine which application to be used and from where it can be downloaded. At least one of said nodes may also be able to inspect the subscriber database in order to check whether the invited user terminal already has obtained the concerned application. Thus, the at least one node may only insert the address if it is confirmed that the invited user does not have access to the application required for the service. It should however be noted that it is possible to implement the arrangements according to the present invention in any node in the IMS, that is able to inspect the Service identifier field in the SIP header.

According to a further embodiment, the arrangements provide means for allowing an inviting end-user to insert the address from where the application may be downloaded by using user inputting means provided by the sending terminal. This may also be accomplished by the concerned application. E.g. a chess application itself may be adapted to insert the address such as a URL in e.g. a SIP INVITE indicating where the chess application can be downloaded.

Accordingly, when the receiving mobile terminal receives the SIP message, exemplified with the SIP INVITE and realizes that it does not have the requested application installed it looks for the “application download URL” in the header or SDP of the SIP INVITE message. The receiving mobile terminal then asks the user if he/she would like to install it. If the end-user agrees the download is started. The SIP set-up may continue or the SIP set-up may also succeed the next time when the end-user wants to start the application. This is however an implementation issue.

As stated above, the address, e.g. a URL, is inserted in a SIP message. Examples of such a SIP message are the SIP INVITE, SIP OPTION, SIP RE-INVITE, SIP NOTIFY and SIP MESSAGE. The address is preferably inserted in the header of the SIP message. A plurality of addresses may be inserted in one single SIP message, preferably in the header of the SIP message. An example of a SIP header with an inserted URL is Application-Download-URL: http://download.telia.com/chess.exe.

One alternative is that the node checks whether the invited end-user already has the concerned application or not before the node inserts the address in the SIP message, preferably the header of the SIP message. This check may be performed by inspecting a subscriber database, wherein the subscription information for each subscriber is stored, e.g. the subscribed services.

The second alternative is that the node by default inserts the address in the SIP message, preferably in the header of the SIP message.

A third alternative is that the invited user requests the address where the application providing the service can be downloaded from the node or from the inviting user terminal.

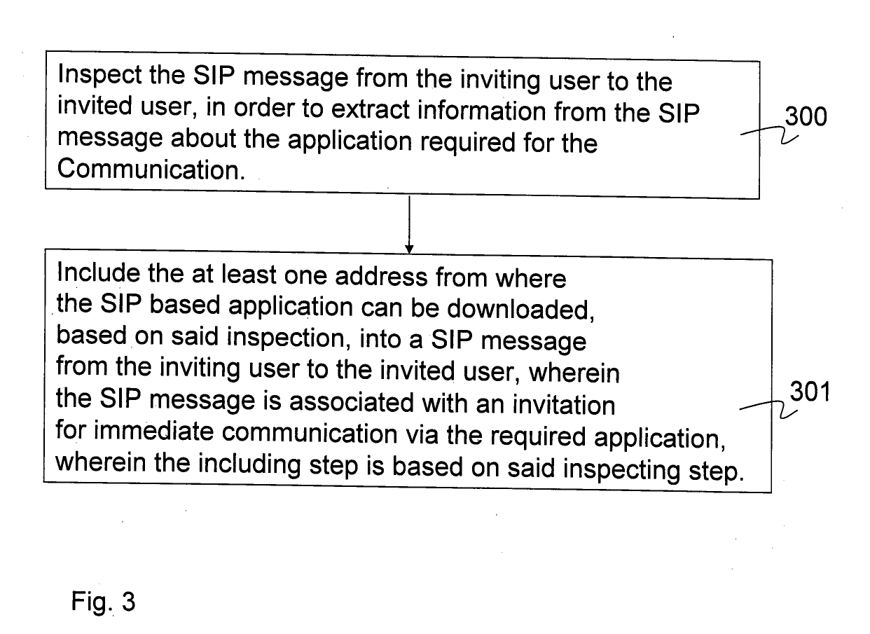

The method of the present invention, illustrated in FIG. 3, comprises the step of: 301. Include the at least one address from where the SIP based application can be downloaded, based on said inspection, into a SIP message from the inviting user to the invited user, wherein the SIP message is associated with an invitation for immediate communication via the required application.

The method may be implemented in a node according to the present invention. Such a node comprises means for including the at least one address from where the SIP based application can be downloaded, based on said inspection, into a SIP message from the inviting user to the invited user, wherein the SIP message is associated with an invitation for immediate communication via the required application. The node may be a mobile terminal or one of the following IMS nodes, sending operator P-CSCF, sending operator S-CSCF, sending operator application server, terminating operator P-CSCF, terminating operator S-CSCF, and terminating operator application server.

In the drawings and specification, there have been disclosed typical preferred embodiments of the invention and, although specific terms are employed, they are used in a generic and descriptive sense only and not for purposes of limitation, the scope of the invention being set forth in the following claims.

1. A method implemented in an Internet Multimedia Subsystem. IMS, adapted to carry Session Initiated Protocol, SIP, traffic between inviting and invited users, for distributing at least one address from where an SIP based application, required for a communication between the users, wherein the type of communication is defined in the invitation form the inviting user, can be downloaded, the method is characterised in that it comprises the step of:
including the at least one address from where the SIP based application can be downloaded into a SIP message from the inviting user to the invited user, wherein the SIP message is associated with the invitation for immediate communication via the required application.

2. The method according to claim 1, characterised in that the including step is preceded by the step of:
inspecting the SIP message from the inviting user to the invited user, in order to extract information from the SIP message about the application required for the communication, wherein the including step is based on said inspecting step.

3. The method according to claim 1, characterised in that the address is a Uniform Resource Locator, URL.

4. The method according to claim 1, characterised in that the address is a Uniform Resource Identifier, URI.

5. The method according to claim 1, characterised in that the address is a Uniform Resource Name. URN.

6. The method according to claim 2, characterised in that the information about the application required for the communication, is the service identifier located in the header of the transmitting SIP message.

7. The method according to claim 1, characterised in that the SIP message is one of SIP INVITE, SIP OPTION, SIP RE-INVITE, SIP NOTIFY and SIP MESSAGE.

8. The method according to claim 2, characterised in that the method is implemented in any of the following IMS nodes: sending operator P-CSCF, sending operator S-CSCF, sending operator application server, terminating operator P-CSCF, terminating operator S-CSCF, and terminating operator application server.

9. The method according to claim 1, characterised in that the method is implemented in the sending terminal of the inviting user.

10. The method according to claim 9, characterised in that the including step is adapted to be performed by the required application.

11. The method according to claim 9, characterised in the including step is adapted to be performed by the inviting user.

12. The method according to any of claims, characterised in that the at least one address from where the SIP based application can be downloaded, is included in the header part of the SIP message.

13. The method according to claim 1, characterised in that the at least one address from where the SIP based application can be downloaded, is included in the body part of the SIP message.

14. A node in an Internet Multimedia Subsystem. IMS, adapted to carry Session Initiated Protocol, SIP, traffic between inviting and invited users, comprising means for distributing at least one address from where an SIP based application, required for a communication between the users, wherein the type of communication is defined in the invitation form the inviting user, can be downloaded, the node is characterised in that it comprises means for including the at least one address from where the SIP based application can be downloaded into a SIP message from the inviting user to the invited user, wherein the SIP message is associated with the invitation for immediate communication via the required application.

15. The node according to claim 14, characterised in that it comprises means for inspecting the SIP message from the inviting user to the invited user, in order to extract information from the SIP message about the application required for the communication, wherein the means for including is adapted to use said extracted information.

16. The node according to claim 14, characterised in that the address is a Uniform Resource Locator, URL.

17. The node according to claim 14, characterised in that the address is a Uniform Resource Identifier, URI.

18. The node according to claim 14, characterised in that the address is a Uniform Resource Name, URN.

19. The node according to claim 15, characterised in that the information about the application required for the communication, is the service identifier located in the header of the transmitting SIP message.

20. The node according to claim 14, characterised in that the SIP message is one of SIP INVITE, SIP OPTION, SIP RE-INVITE, SIP NOTIFY and SIP MESSAGE.

21. The node according to claim 15, characterised in that the node is one of the following IMS nodes: sending operator P-CSCF, sending operator S-CSCF, sending operator application server, terminating operator P-CSCF, terminating operator S-CSCF, and terminating operator application server.

22. The node according to claim 14, characterised in that the node is, or is implemented in, the sending terminal of the inviting user.

23. The node according to claim 22, characterised in that the required application comprises means for including the at least one required application.

24. The node according to claim 22, characterised in the node comprises user inputting means for inputting the at least one address to be included.

25. The node according to claim 14, characterised in that the at least one address from where the SIP based application can be downloaded, is included in the header part of the SIP message.

26. The node according to claim 14, characterised in that the at least one address from where the SIP based application can be downloaded, is included in the body part of the SIP message.
